(19) United States
(12) Patent Application Publication
(10) Pub. No.: US 2024/0027600 A1
(43) Pub. Date: Jan. 25, 2024

(54) Smart-Device-Based Radar System Performing Angular Position Estimation

(71) Applicant: Google LLC, Mountain View, CA (US)

(72) Inventor: Muhammad Muneeb Saleem, Mountain View, CA (US)

(73) Assignee: Google LLC, Mountain View, CA (US)

(21) Appl. No.: 18/040,911

(22) PCT Filed: Aug. 7, 2020
(86) PCT No.: PCT/US2020/045486

§ 371 Date: Feb. 7, 2023

(51) Int. Cl. G01S 13/58; G01S 13/34; G01S 7/41

(52) U.S. Cl. CPC G01S 13/584; G01S 13/345; G01S 7/417

(57) ABSTRACT

Techniques and apparatuses are described that implement a smart-device-based radar system capable of performing angular position estimation. A machine-learned module analyzes complex range data generated to estimate angular positions of objects. The machine-learned module is implemented using a multi-stage architecture. In a local stage, the machine-learned module splits the complex range data into different range intervals and separately processes subsets of the complex range data using individual branch modules. In a global stage, the machine-learned module merges the feature data generated from the individual branch modules using a symmetric function and generates angular position data. By using machine-learning techniques and processing the complex range data directly, the radar system can achieve higher angular resolutions compared to other radar systems that utilize other techniques, such as analog or digital beamforming.

### BACKGROUND

Radars are useful devices that can detect objects. Relative to other types of sensors, like a camera, a radar can provide improved performance in the presence of different environmental conditions, such as low lighting and fog, or with moving or overlapping objects. Radar can also detect objects through one or more occlusions, such as a purse or a pocket. While radar has may advantages, there are many challenges associated with integrating radar in electronic devices.

One such challenge involves restrictions that a small electronic device may impose on a radar's design. To satisfy size or layout constraints, for example, fewer antenna elements may be used. Consequently, the reduced quantity of antenna elements can limit the angular resolution of the radar. With limited angular resolution, it can be challenging for the radar to achieve sufficient angular accuracies for some applications. As such, performance of a radar integrated within an electronic device may be significantly reduced. This can limit the types of applications the radar can support or the types of electronic devices that can incorporate the radar.

### SUMMARY

Techniques and apparatuses are described that implement a smart-device-based radar system capable of performing angular position estimation. In some implementations, the radar system may have a limited quantity of antennas, which can limit the angular resolution realizable using analog or digital beamforming techniques. To overcome this limitation, a machine-learned module analyzes complex range data generated from the radar system to generate angular position data.

The complex range data is organized in terms of range (e.g., slant range or distance). For example, each complex number within the complex range data can be associated with a particular range interval. This organization means that the complex range data has explicit range information for one or more objects within the external environment. The complex range data, however, is not organized in terms of angles (e.g., azimuth and/or elevation angles). Consequently, each complex number within the complex range data can be associated with one or more angles. Because an angular order of the complex numbers within the complex range data is unknown, the complex range data has implicit angular information for the one or more objects within the external environment. With training, the machine-learned module can learn a transformation operation that extracts this angular information directly from the complex range data and determines angular positions of the one or more objects.

The machine-learned module is implemented using a multi-stage architecture. In a first stage (e.g., a local stage), the machine-learned module splits the complex range data into different range intervals and separately processes subsets of the complex range data using individual branch modules. In a second stage (e.g., a global stage), the machine-learned module merges the feature data generated from the individual branch modules using a symmetric function and generates the angular position data. The angular position data can include the quantity of objects detected and/or the positions of these objects. The machine-learned module can represent the positions of these objects using one or more spherical coordinates (e.g., range, azimuth, and/or elevation) or one or more cartesian coordinates (e.g., X, Y, and/or Z). In some cases, the machine-learned module provides information about a boundary of the object (e.g., a size of the object across one or more dimensions).

This multi-stage architecture improves object detection and position accuracy by processing each potential object separately within the local stage and allowing for global and local contexts to be merged in the global stage. By using machine-learning techniques and processing the complex range data directly, the radar system can achieve higher angular resolutions than other radar systems that utilize other angular estimation techniques, such as analog or digital beamforming.

Aspects described below include a method performed by a radar system for angular position estimation. The method includes transmitting a radar transmit signal using a radar system. The method also includes receiving a radar receive signal using multiple receive channels of the radar system. The radar receive signal comprises a version of the radar transmit signal that is reflected by at least one object. The method additionally includes generating complex range data based on the radar receive signal. The complex range data is associated with the multiple receive channels. The method further includes providing the complex range data as input data to a machine-learned module. The method also includes determining an angular position of the at least one object by analyzing the complex range data using the machine-learned module.

Aspects described below also include an apparatus comprising a radar system, a processor, and a computer-readable storage medium. The radar system comprises an antenna array and a transceiver with at least two receive channels respectively coupled to antenna elements of the antenna array. The apparatus also includes a processor and a computer-readable storage medium. The computer-readable storage medium comprises computer-executable instructions that, responsive to execution by the processor, implement a machine-learned module. The radar system, the processor, and the computer-readable storage medium are jointly configured to perform any of the described methods.

Aspects described below include a computer-readable storage medium comprising computer-executable instructions that, responsive to execution by a processor, implement a machine-learned module. The machine-learned module is configured to accept complex range data associated with a radar receive signal that is reflected by at least one object. The complex range data is associated with multiple receive channels of a radar system. The machine-learned module is also configured to separately process different range intervals of the complex range data to generate local feature data for each of the different range intervals. Additionally, the machine-learned module is configured to merge the local feature data using a symmetric function to generate angular position data. The angular position data includes an angular position of the at least one object. The machine-learned module is further configured to determine the angular position of the at least one object based on the angular position data.

Aspects described below also include a system with means for performing angular position estimation based on complex range data.

### BRIEF DESCRIPTION OF DRAWINGS

Apparatuses for and techniques implementing a smart-device-based radar system capable of performing angular position estimation are described with reference to the following drawings. The same numbers are used throughout the drawings to reference like features and components:

FIG. 1 illustrates example environments in which a smart-device-based radar system capable of performing angular position estimation can be implemented;

FIG. 2 illustrates an example implementation of a radar system as part of a smart device;

FIG. 3-1 illustrates operation of an example radar system;

FIG. 3-2 illustrates an example radar framing structure for angular position estimation;

FIG. 4 illustrates an example antenna array and an example transceiver of a radar system;

FIG. 5 illustrates an example scheme implemented by a radar system for performing angular position estimation using a machine-learned module.

FIG. 6-1 illustrates an example hardware-abstraction module for angular position estimation;

FIG. 6-2 illustrates example complex range data generated by a hardware-abstraction module for angular position estimation;

FIG. 7-1 illustrates an example machine-learned module for performing angular position estimation;

FIG. 7-2 illustrates an example local stage of a machine-learned module;

FIG. 7-3 illustrates an example global stage of a machine-learned module;

FIG. 8 illustrates an example method for performing operations of a smart-device-based radar system capable of performing angular position estimation; and

FIG. 9 illustrates an example computing system embodying, or in which techniques may be implemented that enable use of, a radar system capable of performing angular position estimation.

### DETAILED DESCRIPTION

Integrating a radar system within an electronic device can be challenging. The electronic device, for example, may have a limited amount of available space. To meet a size or layout constraint of the electronic device, the radar system can be implemented with fewer antennas, less memory, or less processing capability to reduce an overall size of the radar system. This can make it challenging, however, for some angular estimation techniques to be implemented and enable the radar system to realize a target angular resolution.

Some angular estimation techniques use analog or digital beamforming. Example types of digital beamforming techniques can employ a classical beamforming algorithm (e.g., a Bartlett algorithm) or a super-resolution or adaptive beamforming algorithm (e.g., an iterative adaptive approach (IAA), a minimum variance distortionless response (MVDR) beamforming algorithm, (e.g., a CAPON beamforming algorithm), or a multiple signal classification (MUSIC) beamforming algorithm).

Unfortunately, the angular resolution that can be realized using analog or digital beamforming is directly dependent upon the quantity of antennas that are available. Therefore, it can be challenging for a radar system that uses either of these techniques with a limited number of antenna elements (e.g., two, three, or four antenna elements) to realize sufficient angular resolution for detecting a presence of a user, distinguishing between multiple users, or recognizing gestures. Furthermore, some digital beamforming techniques can be computationally expensive. Therefore, radar systems with limited memory or limited processing capability may be unable to quickly execute an algorithm associated with the digital beamforming technique.

To address such challenges, techniques are described that implement a smart-device-based radar system capable of performing angular position estimation. In some implementations, the radar system may have a limited quantity of antennas, which can limit the angular resolution realizable using analog or digital beamforming techniques. To overcome this limitation, a machine-learned module analyzes complex range data generated from the radar system to generate angular position data.

The complex range data is organized in terms of range (e.g., slant range or distance). For example, each complex number within the complex range data can be associated with a particular range interval. This organization means that the complex range data has explicit range information for one or more objects within the external environment. The complex range data, however, is not organized in terms of angles (e.g., azimuth and/or elevation angles). Consequently, each complex number within the complex range data can be associated with one or more angles. Because an angular order of the complex numbers within the complex range data is unknown, the complex range data has implicit angular information for the one or more objects within the external environment. With training, the machine-learned module can learn a transformation operation that extracts this angular information directly from the complex range data and determines angular positions of the one or more objects.

The machine-learned module is implemented using a multi-stage architecture. In a first stage (e.g., a local stage), the machine-learned module splits the complex range data into different range intervals and separately processes subsets of the complex range data using individual branch modules. In a second stage (e.g., a global stage), the machine-learned module merges the feature data generated from the individual branch modules using a symmetric function and generates the angular position data. The angular position data can include the quantity of objects detected and/or the positions of these objects. The machine-learned module can represent the positions of these objects using one or more spherical coordinates (e.g., range, azimuth, and/or elevation) or one or more cartesian coordinates (e.g., X, Y, and/or Z). In some cases, the machine-learned module provides information about a boundary of the object (e.g., a size of the object across one or more dimensions).

This multi-stage architecture improves object detection and position accuracy by processing each potential object separately within the local stage and allowing for global and local contexts to be merged in the global stage. By using machine-learning techniques and processing the complex range data directly, the radar system can achieve higher angular resolutions than other radar systems that utilize other angular estimation techniques, such as analog or digital beamforming.

### Operating Environment

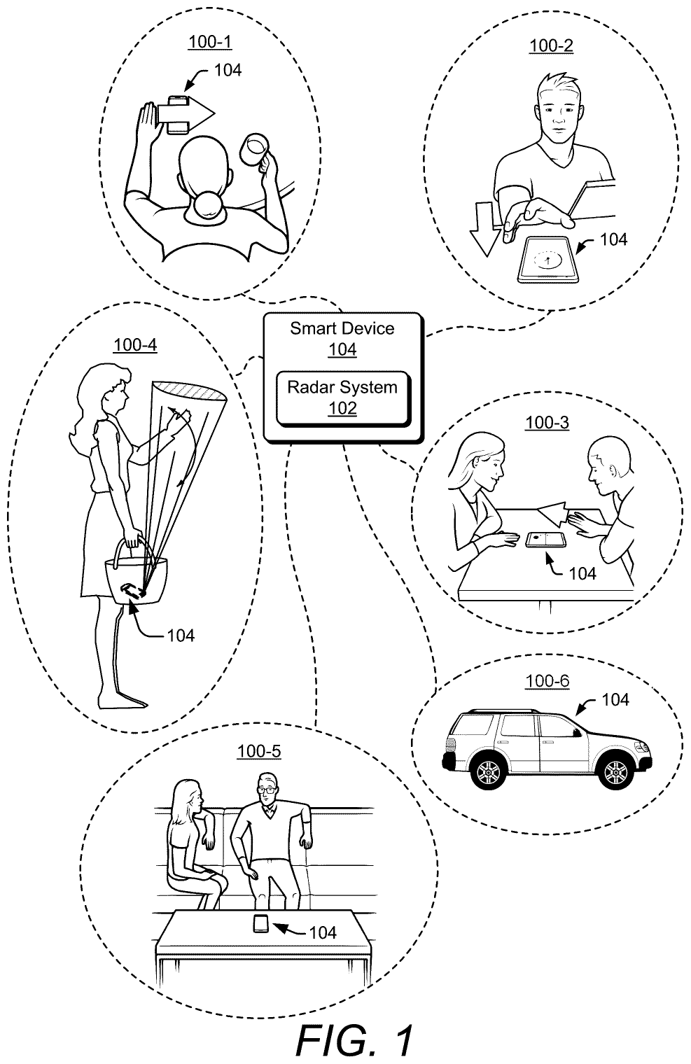

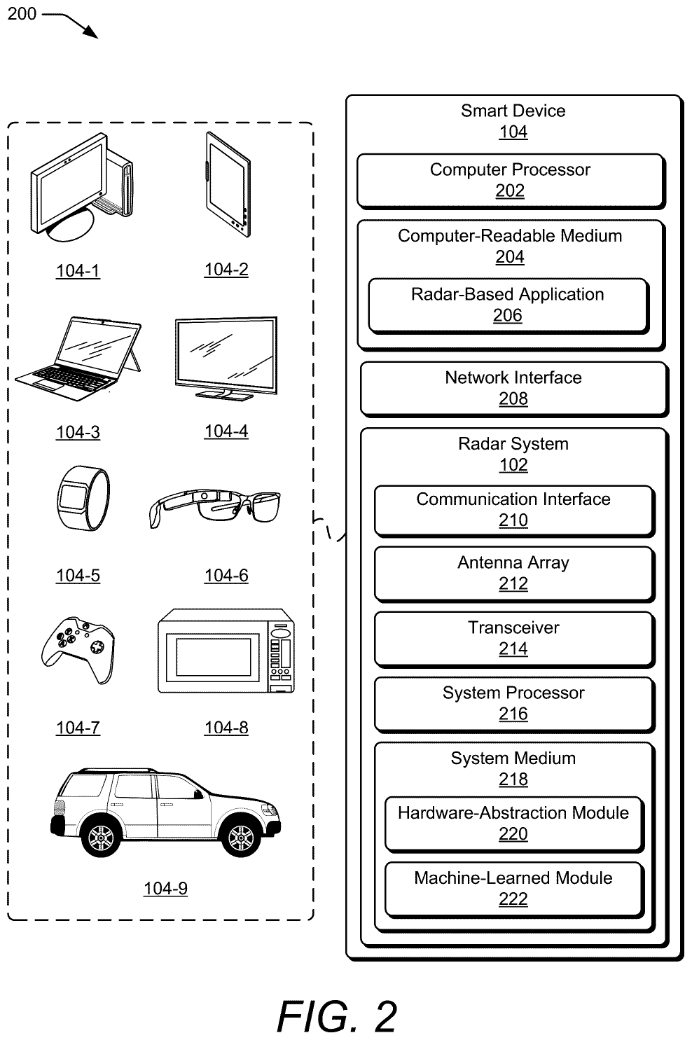

FIG. 1 is an illustration of example environments 100-1 to 100-6 in which techniques using, and an apparatus including, a smart-device-based radar system capable of performing angular position estimation may be embodied. In the depicted environments 100-1 to 100-6, a smart device 104 includes a radar system 102 capable of detecting one or more objects (e.g., users) using a machine-learned module (of FIG. 2). The smart device 104 is shown to be a smartphone in environments 100-1 to 100-5 and a smart vehicle in the environment 100-6.

In the environments 100-1 to 100-4, a user performs different types of gestures, which are detected by the radar system 102. In some cases, the user performs a gesture using an appendage or body part. Alternatively, the user can also perform a gesture using a stylus, a hand-held object, a ring, or any type of material that can reflect radar signals. By performing angular position estimation over time as the apparatus that performs the gesture, the radar system 102 can recognize the gesture that is performed. The radar system 102 can also use angular position estimation to distinguish between multiple users, which may or may not be at a same distance (e.g., slant range) from the radar system 102.

In environment 100-1, the user makes a scrolling gesture by moving a hand above the smart device 104 along a horizontal dimension (e.g., from a left side of the smart device 104 to a right side of the smart device 104). In the environment 100-2, the user makes a reaching gesture, which decreases a distance between the smart device 104 and the user's hand. The users in environment 100-3 make hand gestures to play a game on the smart device 104. In one instance, a user makes a pushing gesture by moving a hand above the smart device 104 along a vertical dimension (e.g., from a bottom side of the smart device 104 to a top side of the smart device 104). Using angular position estimation, the radar system 102 can recognize the gestures performed by the user. In the environment 100-4, the smart device 104 is stored within a purse, and the radar system 102 provides occluded-gesture recognition by detecting gestures that are occlude by the purse.

The radar system 102 can also recognize other types of gestures or motions not shown in FIG. 1. Example types of gestures include a knob-turning gesture in which a user curls their fingers to grip an imaginary doorknob and rotate their fingers and hand in a clockwise or counter-clockwise fashion to mimic an action of turning the imaginary doorknob. Another example type of gesture includes a spindle-twisting gesture, which a user performs by rubbing a thumb and at least one other finger together. The gestures can be two-dimensional, such as those used with touch-sensitive displays (e.g., a two-finger pinch, a two-finger spread, or a tap). The gestures can also be three-dimensional, such as many sign-language gestures, e.g., those of American Sign Language (ASL) and other sign languages worldwide. Upon detecting each of these gestures, the smart device 104 can perform an action, such as display new content, move a cursor, activate one or more sensors, open an application, and so forth. In this way, the radar system 102 provides touch-free control of the smart device 104.

In the environment 100-5, the radar system 102 generates a three-dimensional map of a surrounding environment for contextual awareness. The radar system 102 also detects and tracks multiple users to enable both users to interact with the smart device 104. The radar system 102 can also perform vital-sign detection. In the environment 100-6, the radar system 102 monitors vital signs of a user that drives a vehicle. Example vital signs include a heart rate and a respiration rate. If the radar system 102 determines that the driver is falling asleep, for instance, the radar system 102 can cause the smart device 104 to alert the user. Alternatively, if the radar system 102 detects a life threatening emergency, such as a heart attack, the radar system 102 can cause the smart device 104 to alert a medical professional or emergency services. In some implementations, the radar system 102 in the environment 100-6 can support collision avoidance for autonomous driving.

Some implementations of the radar system 102 are particularly advantageous as applied in the context of smart devices 104, for which there is a convergence of issues. This can include a need for limitations in a spacing and layout of the radar system 102 and low power. Exemplary overall lateral dimensions of the smart device 104 can be, for example, approximately eight centimeters by approximately fifteen centimeters. Exemplary footprints of the radar system 102 can be even more limited, such as approximately four millimeters by six millimeters with antennas included. Exemplary power consumption of the radar system 102 may be on the order of a few milliwatts to tens of milliwatts (e.g., between approximately two milliwatts and twenty milliwatts). The requirement of such a limited footprint and power consumption for the radar system 102 enables the smart device 104 to include other desirable features in a space-limited package (e.g., a camera sensor, a fingerprint sensor, a display, and so forth). The smart device 104 and the radar system 102 are further described with respect to FIG. 2.

FIG. 2 illustrates the radar system 102 as part of the smart device 104. The smart device 104 is illustrated with various non-limiting example devices including a desktop computer 104-1, a tablet 104-2, a laptop 104 3, a television 104-4, a computing watch 104-5, computing glasses 104-6, a gaming system 104-7, a microwave 104-8, and a vehicle 104-9. Other devices may also be used, such as a home service device, a smart speaker, a smart thermostat, a security camera, a baby monitor, a Wi-Fi™ router, a drone, a trackpad, a drawing pad, a netbook, an e-reader, a home automation and control system, a wall display, and another home appliance. Note that the smart device 104 can be wearable, non-wearable but mobile, or relatively immobile (e.g., desktops and appliances). The radar system 102 can be used as a stand-alone radar system or used with, or embedded within, many different smart devices 104 or peripherals, such as in control panels that control home appliances and systems, in automobiles to control internal functions (e.g., volume, cruise control, or even driving of the car), or as an attachment to a laptop computer to control computing applications on the laptop.

The smart device 104 includes one or more computer processors 202 and at least one computer-readable medium 204, which includes memory media and storage media. Applications and/or an operating system (not shown) embodied as computer-readable instructions on the computer-readable medium 204 can be executed by the computer processor 202 to provide some of the functionalities described herein. The computer-readable medium 204 also includes a radar-based application 206, which uses radar data generated by the radar system 102 to perform a function, such as presence detection, gesture-based touch-free control, collision avoidance for autonomous driving, human vital-sign notification, and so forth.

The smart device 104 can also include a network interface 208 for communicating data over wired, wireless, or optical networks. For example, the network interface 208 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, and the like. The smart device 104 may also include a display (not shown).

The radar system 102 includes a communication interface 210 to transmit the radar data to a remote device, though this need not be used when the radar system 102 is integrated within the smart device 104. In general, the radar data provided by the communication interface 210 is in a format usable by the radar-based application 206.

The radar system 102 also includes at least one antenna array 212 and at least one transceiver 214 to transmit and receive radar signals. The antenna array 212 includes at least one transmit antenna element and at least two receive antenna elements. In some situations, the antenna array 212 includes multiple transmit antenna elements to implement a multiple-input multiple-output (MIMO) radar capable of transmitting multiple distinct waveforms at a given time (e.g., a different waveform per transmit antenna element). The antenna elements can be circularly polarized, horizontally polarized, vertically polarized, or a combination thereof.

The receive antenna elements of the antenna array 212 can be positioned in a one-dimensional shape (e.g., a line) or a two-dimensional shape (e.g., a rectangular arrangement, a triangular arrangement, or an “L” shape arrangement) for implementations that include three or more receive antenna elements. The one-dimensional shape enables the radar system 102 to measure one angular dimension (e.g., an azimuth or an elevation) while the two-dimensional shape enables the radar system 102 to measure two angular dimensions (e.g., to determine both an azimuth angle and an elevation angle of the object). An element spacing associated with the receive antenna elements can be less than, greater than, or equal to half a center wavelength of the radar signal.

The transceiver 214 includes circuitry and logic for transmitting and receiving radar signals via the antenna array 212. Components of the transceiver 214 can include amplifiers, phase shifters, mixers, switches, analog-to-digital converters, or filters for conditioning the radar signals. The transceiver 214 also includes logic to perform in phase/quadrature (I/Q) operations, such as modulation or demodulation. A variety of modulations can be used, including linear frequency modulations, triangular frequency modulations, stepped frequency modulations, or phase modulations. Alternatively, the transceiver 214 can produce radar signals having a relatively constant frequency or a single tone. The transceiver 214 can be configured to support continuous-wave or pulsed radar operations.

A frequency spectrum (e.g., range of frequencies) that the transceiver 214 uses to generate the radar signals can encompass frequencies between 1 and 400 gigahertz (GHz), between 4 and 100 GHz, between 1 and 24 GHz, between 2 and 4 GHz, between 57 and 64 GHz, or at approximately 2.4 GHz. In some cases, the frequency spectrum can be divided into multiple sub-spectrums that have similar or different bandwidths. The bandwidths can be on the order of 500 megahertz (MHz), 1 GHz, 2 GHz, and so forth. In some cases, the bandwidths are approximately 20% or more of a center frequency to implement an ultrawideband radar.

Different frequency sub-spectrums may include, for example, frequencies between approximately 57 and 59 GHz, 59 and 61 GHz, or 61 and 63 GHz. Although the example frequency sub-spectrums described above are contiguous, other frequency sub-spectrums may not be contiguous. To achieve coherence, multiple frequency sub-spectrums (contiguous or not) that have a same bandwidth may be used by the transceiver 214 to generate multiple radar signals, which are transmitted simultaneously or separated in time. In some situations, multiple contiguous frequency sub-spectrums may be used to transmit a single radar signal, thereby enabling the radar signal to have a wide bandwidth.

The radar system 102 also includes one or more system processors 216 and at least one system medium 218 (e.g., one or more computer-readable storage media). The system medium 218 optionally includes a hardware-abstraction module 220. The system medium 218 also includes at least machine-learned module 222. The hardware-abstraction module 220 and the machine-learned module 222 can be implemented using hardware, software, firmware, or a combination thereof. In this example, the system processor 216 implements the hardware-abstraction module 220 and the machine-learned module 222. Together, the hardware-abstraction module 220 and the machine-learned module 222 enable the system processor 216 to process responses from the receive antenna elements in the antenna array 212 to detect a user, determine a position of the user, and/or recognize a gesture performed by the user.

In an alternative implementation (not shown), the hardware-abstraction module 220 or the machine-learned module 222 are included within the computer-readable medium 204 and implemented by the computer processor 202. This enables the radar system 102 to provide the smart device 104 raw data via the communication interface 210 such that the computer processor 202 can process the raw data for the radar-based application 206.

The hardware-abstraction module 220 transforms raw data provided by the transceiver 214 into hardware-agnostic data, which can be processed by the machine-learned module 222. In particular, the hardware-abstraction module 220 conforms complex data from a variety of different types of radar signals to an expected input of machine-learned module 222. This enables the machine-learned module 222 to process different types of radar signals received by the radar system 102, including those that utilize different modulations schemes for frequency-modulated continuous-wave radar, phase-modulated spread spectrum radar, or impulse radar. The hardware-abstraction module 220 can also normalize complex data from radar signals with different center frequencies, bandwidths, transmit power levels, or pulsewidths.

Additionally, the hardware-abstraction module 220 conforms complex data generated using different hardware architectures. Different hardware architectures can include different antenna arrays 212 positioned on different surfaces of the smart device 104 or different sets of antenna elements within an antenna array 212. By using the hardware-abstraction module 220, the machine-learned module 222 can process complex data generated by different sets of antenna elements with different gains, different sets of antenna elements of various quantities, or different sets of antenna elements with different antenna element spacings.

By using the hardware-abstraction module 220, the machine-learned module 222 can operate in radar systems 102 with different limitations that affect the available radar modulation schemes, transmission parameters, or types of hardware architectures. The hardware-abstraction module 220 is further described with respect to FIGS. 6-1 to 6-3.

The machine-learned module 222 analyzes the hardware-agnostic data and generates angular position data, which can be provided to other modules within the system medium 218, such as a presence-detection module, a gesture-recognition module, a position-estimation module, or a collision-avoidance module. Using the angular position data, the radar system 102 can generate radar-application data for the radar-based application 206. Example types of radar-application data include a position of a user, movement of the user, a type of gesture performed by the user, a measured vital-sign of the user, or characteristics of an object.

In some cases, the machine-learned module 222 includes a suite of machine-learning architectures that can be individually selected according to the type of smart device 104 or the radar-based application 206. Designs of the machine-learning architectures can be tailored to support smart devices 104 with different amounts of available memory, different amounts available power, or different computational capabilities.

The machine-learned module is implemented using a multi-stage architecture. In a first stage, the machine-learned module splits the complex range data into different range intervals and separately processes subsets of the complex range data using individual branch modules. In a second stage, the machine-learned module merges the feature data generated from the individual branch modules using a symmetric function and generates the angular position data. This multi-stage architecture improves object detection and position accuracy by processing each potential object separately within the local stage and allowing for global and local contexts to be merged in the global stage. By using machine-learning techniques and processing the complex range data directly, the radar system can achieve higher angular resolutions than other radar systems that utilize other angular estimation techniques, such as analog or digital beamforming. The machine-learned module 222 is further described with respect to FIGS. 7-1 to 7-3.

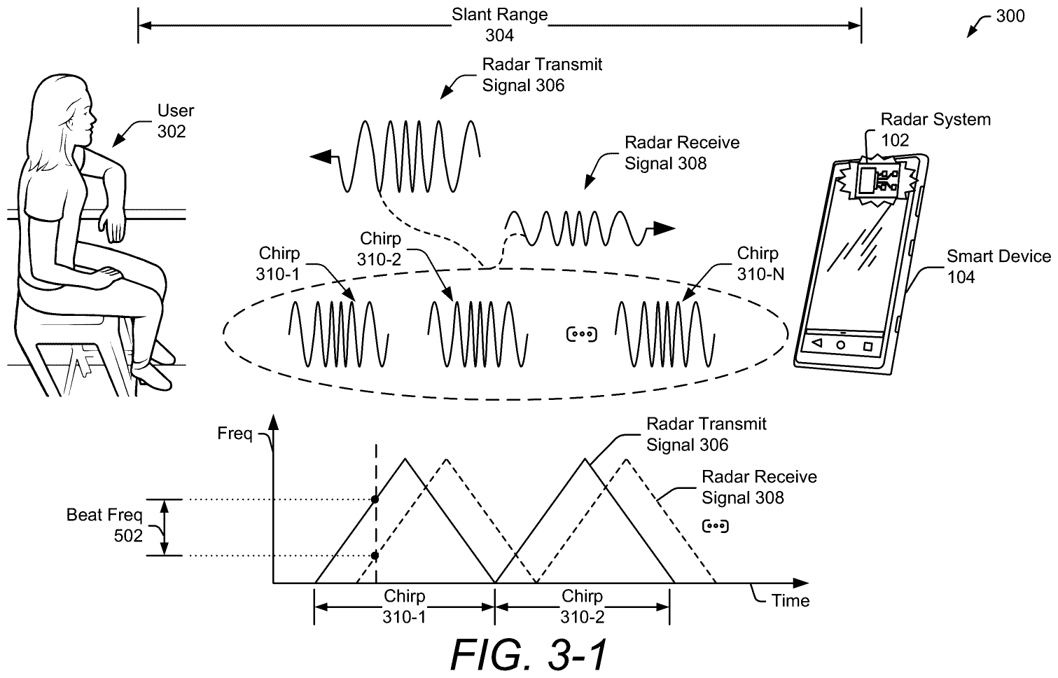

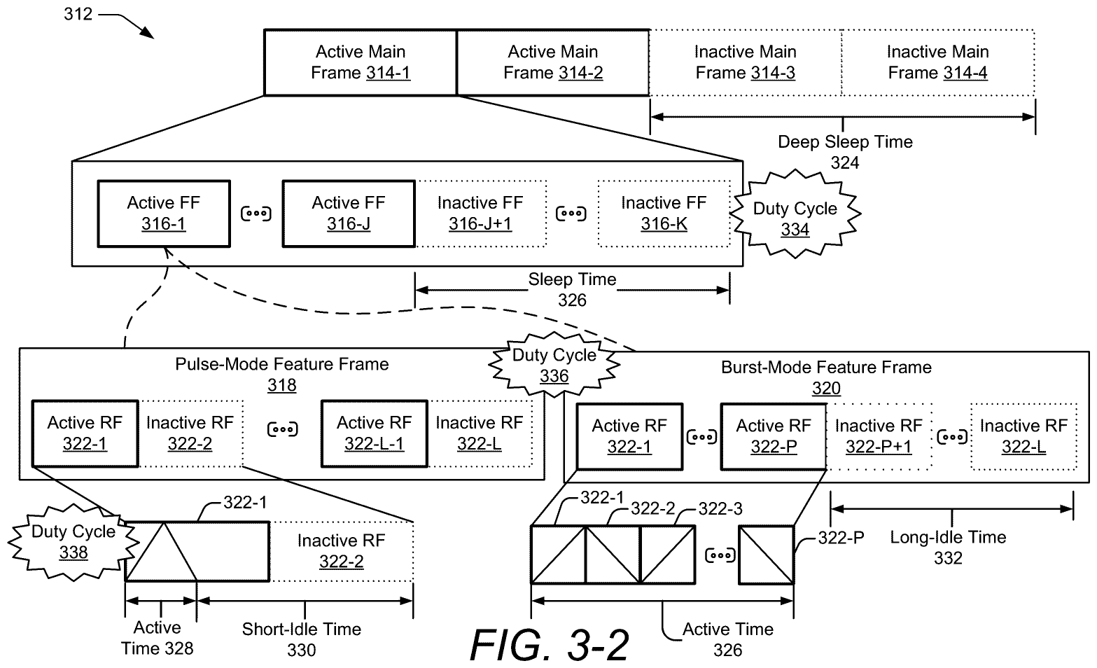

FIG. 3-1 illustrates an example operation of the radar system 102. In the depicted configuration, the radar system 102 is implemented as a frequency-modulated continuous-wave radar. However, other types of radar architectures can be implemented, as described above with respect to FIG. 2. In environment 300, a user 302 is located at a particular slant range 304 from the radar system 102. To detect the user 302, the radar system 102 transmits a radar transmit signal 306. At least a portion of the radar transmit signal 306 is reflected by the user 302. This reflected portion represents a radar receive signal 308. The radar system 102 receives the radar receive signal 308 and processes the radar receive signal 308 to extract data for the radar-based application 206. As depicted, an amplitude of the radar receive signal 308 is smaller than an amplitude of the radar transmit signal 306 due to losses incurred during propagation and reflection.

The radar transmit signal 306 includes a sequence of chirps 310-1 to 310-N, where N represents a positive integer greater than one. The radar system 102 can transmit the chirps 310-1 to 310-N in a continuous burst or transmit the chirps 310-1 to 310-N as time-separated pulses, as further described with respect to FIG. 3-2. A duration of each chirp 310-1 to 310-N can be on the order of tens or thousands of microseconds (e.g., between approximately 30 microseconds (μs) and 5 milliseconds (ms)), for instance.

Individual frequencies of the chirps 310 1 to 310-N can increase or decrease overtime. In the depicted example, the radar system 102 employs a two-slope cycle (e.g., triangular frequency modulation) to linearly increase and linearly decrease the frequencies of the chirps 310-1 to 310-N over time. The two-slope cycle enables the radar system 102 to measure the Doppler frequency shift caused by motion of the user 302. In general, transmission characteristics of the chirps 310-1 to 310-N(e.g., bandwidth, center frequency, duration, and transmit power) can be tailored to achieve a particular detection range, range resolution, or Doppler sensitivity for detecting one or more characteristics the user 302 or one or more actions performed by the user 302.

At the radar system 102, the radar receive signal 308 represents a delayed version of the radar transmit signal 306. The amount of delay is proportional to the slant range 304 (e.g., distance) from the antenna array 212 of the radar system 102 to the user 302. In particular, this delay represents a summation of a time it takes for the radar transmit signal 306 to propagate from the radar system 102 to the user 302 and a time it takes for the radar receive signal 308 to propagate from the user 302 to the radar system 102. If the user 302 is moving, the radar receive signal 308 is shifted in frequency relative to the radar transmit signal 306 due to the Doppler effect. Similar to the radar transmit signal 306, the radar receive signal 308 is composed of one or more of the chirps 310-1 to 310 N.

The multiple chirps 310-1 to 310-N enable the radar system 102 to make multiple observations of the user 302 over a predetermined time period. A radar framing structure determines a timing of the chirps 310-1 to 310-N, as further described with respect to FIG. 3-2.

FIG. 3-2 illustrates an example radar framing structure 312 for angular position estimation. In the depicted configuration, the radar framing structure 312 includes three different types of frames. At a top level, the radar framing structure 312 includes a sequence of main frames 314, which can be in the active state or the inactive state. Generally speaking, the active state consumes a larger amount of power relative to the inactive state. At an intermediate level, the radar framing structure 312 includes a sequence of feature frames 316, which can similarly be in the active state or the inactive state. Different types of feature frames 316 include a pulse-mode feature frame 318 (shown at the bottom-left of FIG. 3-2) and a burst-mode feature frame 320 (shown at the bottom-right of FIG. 3-2). At a low level, the radar framing structure 312 includes a sequence of radar frames (RF) 322, which can also be in the active state or the inactive state.

The radar system 102 transmits and receives a radar signal during an active radar frame 322. In some situations, the radar frames 322 are individually analyzed for basic radar operations, such as search and track, clutter map generation, user location determination, and so forth. Radar data collected during each active radar frame 322 can be saved to a buffer after completion of the radar frame 322 or provided directly to the system processor 216 of FIG. 2.

The radar system 102 analyzes the radar data across multiple radar frames 322 (e.g., across a group of radar frames 322 associated with an active feature frame 316) to identify a particular feature. Example types of features include a particular type of motion, a motion associated with a particular appendage (e.g., a hand or individual fingers), and a feature associated with different portions of the gesture. To analyze movement of the user 302 or recognize a gesture performed by the user 302 during an active main frame 314, the radar system 102 analyzes the radar data associated with one or more active feature frames 316.

A duration of the main frame 314 may be on the order of milliseconds or seconds (e.g., between approximately 10 ms and 10 seconds (s)). After active main frames 314-1 and 314-2 occur, the radar system 102 is inactive, as shown by inactive main frames 314-3 and 314-4. A duration of the inactive main frames 314-3 and 314-4 is characterized by a deep sleep time 324, which may be on the order of tens of milliseconds or more (e.g., greater than 50 ms). In an example implementation, the radar system 102 turns off all of the active components (e.g., an amplifier, an active filter, a voltage-controlled oscillator (VCO), a voltage-controlled buffer, a multiplexer, an analog-to-digital converter, a phase-lock loop (PLL) or a crystal oscillator) within the transceiver 214 to conserve power during the deep sleep time 324.

In the depicted radar framing structure 312, each main frame 314 includes K feature frames 316, where K is a positive integer. If the main frame 314 is in the inactive state, all of the feature frames 316 associated with that main frame 314 are also in the inactive state. In contrast, an active main frame 314 includes J active feature frames 316 and K-J inactive feature frames 316, where J is a positive integer that is less than or equal to K. A quantity of feature frames 316 can be adjusted based on a complexity of the environment or a complexity of a gesture. For example, a main frame 314 can include a few to a hundred feature frames 316 (e.g., K may equal 2, 10, 30, 60, or 100). A duration of each feature frame 316 may be on the order of milliseconds (e.g., between approximately 1 ms and 50 ms).

To conserve power, the active feature frames 316-1 to 316-J occur prior to the inactive feature frames 316-(J+1) to 316-K. A duration of the inactive feature frames 316-(J+1) to 316-K is characterized by a sleep time 326. In this way, the inactive feature frames 316-(J+1) to 316-K are consecutively executed such that the radar system 102 can be in a powered-down state for a longer duration relative to other techniques that may interleave the inactive feature frames 316-(J+1) to 316-K with the active feature frames 316-1 to 316-J. Generally speaking, increasing a duration of the sleep time 326 enables the radar system 102 to turn off components within the transceiver 214 that require longer start-up times.

Each feature frame 316 includes L radar frames 322, where L is a positive integer that may or may not be equal to J or K. In some implementations, a quantity of radar frames 322 may vary across different feature frames 316 and may comprise a few frames or hundreds of frames (e.g., L may equal 5, 15, 30, 100, or 500). A duration of a radar frame 322 may be on the order of tens or thousands of microseconds (e.g., between approximately 30 μs and 5 ms). The radar frames 322 within a particular feature frame 316 can be customized for a predetermined detection range, range resolution, or doppler sensitivity, which facilitates detection of a particular feature or gesture. For example, the radar frames 322 may utilize a particular type of modulation, bandwidth, frequency, transmit power, or timing. If the feature frame 316 is in the inactive state, all of the radar frames 322 associated with that feature frame 316 are also in the inactive state.

The pulse-mode feature frame 318 and the burst-mode feature frame 320 include different sequences of radar frames 322. Generally speaking, the radar frames 322 within an active pulse-mode feature frame 318 transmit pulses that are separated in time by a predetermined amount. This disperses observations over time, which can make it easier for the radar system 102 to recognize a gesture due to larger changes in the observed chirps 310-1 to 310-N within the pulse-mode feature frame 318 relative to the burst-mode feature frame 320. In contrast, the radar frames 322 within an active burst-mode feature frame 320 transmit pulses continuously across a portion of the burst-mode feature frame 320 (e.g., the pulses are not separated by a predetermined amount of time). This enables an active-burst-mode feature frame 320 to consume less power than the pulse-mode feature frame 318 by turning off a larger quantity of components, including those with longer start-up times, as further described below.

Within each active pulse-mode feature frame 318, the sequence of radar frames 322 alternates between the active state and the inactive state. Each active radar frame 322 transmits a chirp 310 (e.g., a pulse), which is illustrated by a triangle. A duration of the chirp 310 is characterized by an active time 328. During the active time 328, components within the transceiver 214 are powered-on. During a short-idle time 330, which includes the remaining time within the active radar frame 322 and a duration of the following inactive radar frame 322, the radar system 102 conserves power by turning off one or more active components within the transceiver 214 that have a start-up time within a duration of the short-idle time 330.

An active burst-mode feature frame 320 includes P active radar frames 322 and L-P inactive radar frames 322, where P is a positive integer that is less than or equal to L. To conserve power, the active radar frames 322-1 to 322-P occur prior to the inactive radar frames 322-(P+1) to 322-L. A duration of the inactive radar frames 322-(P+1) to 322-L is characterized by a long-idle time 332. By grouping the inactive radar frames 322-(P+1) to 322-L together, the radar system 102 can be in a powered-down state for a longer duration relative to the short-idle time 330 that occurs during the pulse-mode feature frame 318. Additionally, the radar system 102 can turn off additional components within the transceiver 214 that have start-up times that are longer than the short-idle time 330 and shorter than the long-idle time 332.

Each active radar frame 322 within an active burst-mode feature frame 320 transmits a portion of the chirp 310. In this example, the active radar frames 322-1 to 322-P alternate between transmitting a portion of the chirp 310 that increases in frequency and a portion of the chirp 310 that decreases in frequency.

The radar framing structure 312 enables power to be conserved through adjustable duty cycles within each frame type. A first duty cycle 334 is based on a quantity of active feature frames 316 (J) relative to a total quantity of feature frames 316 (K). A second duty cycle 336 is based on a quantity of active radar frames 322 (e.g., L/2 or P) relative to a total quantity of radar frames 322 (L). A third duty cycle 338 is based on a duration of the chirp 310 relative to a duration of a radar frame 322.

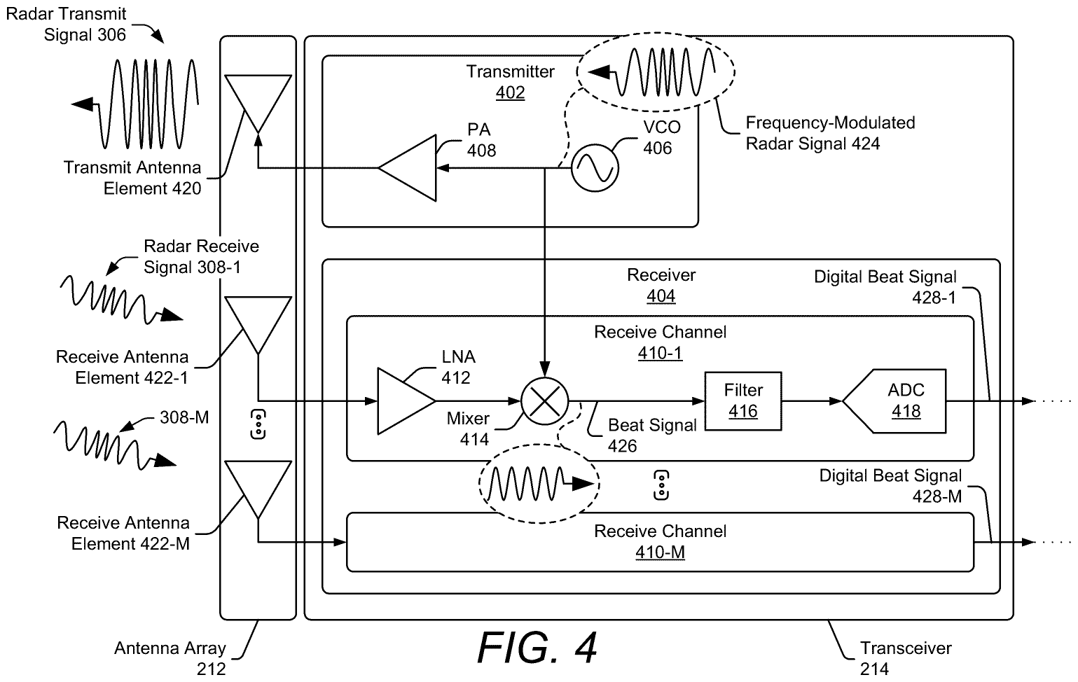

Consider an example radar framing structure 312 for a power state that consumes approximately 2 milliwatts (mW) of power and has a main-frame update rate between approximately 1 and 4 hertz (Hz). In this example, the radar framing structure 312 includes a main frame 314 with a duration between approximately 250 ms and 1 second. The main frame 314 includes thirty-one pulse-mode feature frames 318 (e.g., K is equal to 31). One of the thirty-one pulse-mode feature frames 318 is in the active state. This results in the duty cycle 334 being approximately equal to 3.2%. A duration of each pulse-mode feature frame 318 is between approximately 8 and 32 ms. Each pulse-mode feature frame 318 is composed of eight radar frames 322 (e.g., L is equal to 8). Within the active pulse-mode feature frame 318, all eight radar frames 322 are in the active state. This results in the duty cycle 336 being equal to 100%. A duration of each radar frame 322 is between approximately 1 and 4 ms. An active time 328 within each of the active radar frames 322 is between approximately 32 and 128 μs. As such, the resulting duty cycle 338 is approximately 3.2%. This example radar framing structure 312 has been found to yield good performance results. These good performance results are in terms of good angular position estimation, gesture recognition, and presence detection while also yielding good power efficiency results in the application context of a handheld smartphone in a low-power state. Generation of the radar transmit signal 306 (of FIG. 3-1) and the processing of the radar receive signal 308 (of FIG. 3-1) are further described with respect to FIG. 4.

FIG. 4 illustrates an example antenna array 212 and an example transceiver 214 of the radar system 102. In the depicted configuration, the transceiver 214 includes a transmitter 402 and a receiver 404. The transmitter 402 includes at least one voltage-controlled oscillator 406 and at least one power amplifier 408. The receiver 404 includes at least two receive channels 410-1 to 410-M, where M is a positive integer greater than one. Each receive channel 410-1 to 410-M includes at least one low-noise amplifier 412, at least one mixer 414, at least one filter 416, and at least one analog-to-digital converter 418. The antenna array 212 includes at least one transmit antenna element 420 and at least two receive antenna elements 422-1 to 422-M. The transmit antenna element 420 is coupled to the transmitter 402. The receive antenna elements 422-1 to 422-M are respectively coupled to the receive channels 410-1 to 410-M.

During transmission, the voltage-controlled oscillator 406 generates a frequency-modulated radar signal 424 at radio frequencies. The power amplifier 408 amplifies the frequency-modulated radar signal 424 for transmission via the transmit antenna element 420. The transmitted frequency-modulated radar signal 424 is represented by the radar transmit signal 306, which can include multiple chirps 310-1 to 310-N based on the radar framing structure 312 of FIG. 3-2. As an example, the radar transmit signal 306 is generated according to the burst-mode feature frame 320 of FIG. 3-2 and includes 16 chirps 310 (e.g., N equals 16).

During reception, each receive antenna element 422-1 to 422-M receives a version of the radar receive signal 308-1 to 308-M. In general, relative phase differences between these versions of the radar receive signals 308-1 to 308-M are due to differences in locations of the receive antenna elements 422-1 to 422-M. Within each receive channel 410-1 to 410-M, the low-noise amplifier 412 amplifies the radar receive signal 308, and the mixer 414 mixes the amplified radar receive signal 308 with the frequency-modulated radar signal 424. In particular, the mixer performs a beating operation, which downconverts and demodulates the radar receive signal 308 to generate a beat signal 426.

A frequency of the beat signal 426 represents a frequency difference between the frequency-modulated radar signal 424 and the radar receive signal 308, which is proportional to the slant range 304 of FIG. 3-1. Although not shown, the beat signal 426 can include multiple frequencies, which represents reflections from different portions of the user 302 (e.g., different fingers, different portions of a hand, or different body parts). In some cases, these different portions move at different speeds, move in different directions, or are positioned at different slant ranges relative to the radar system 102.

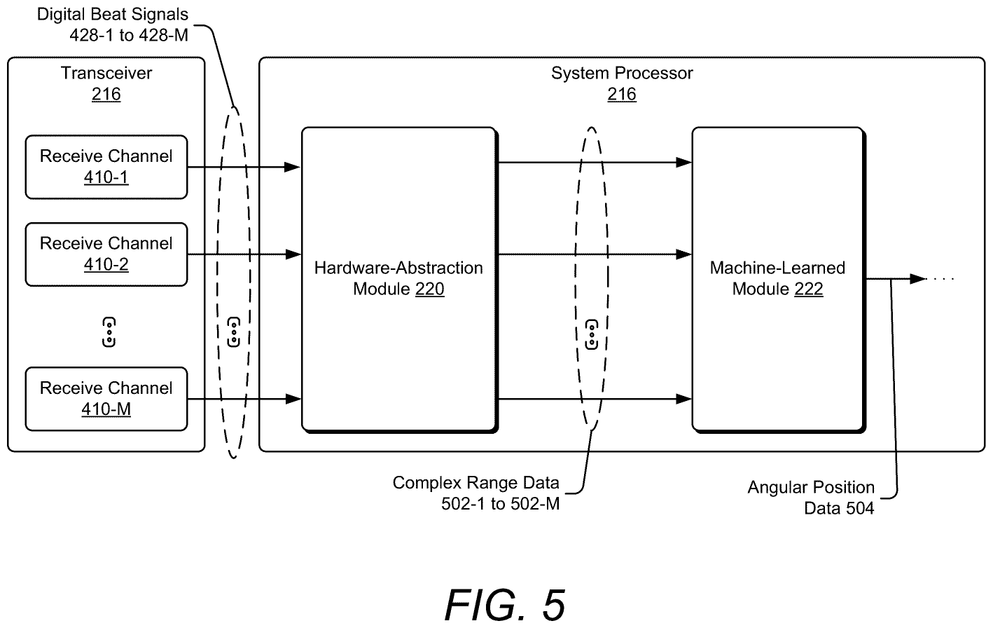

The filter 416 filters the beat signal 426, and the analog-to-digital converter 418 digitizes the filtered beat signal 426. The receive channels 410-1 to 410-M respectively generate digital beat signals 428-1 to 428-M, which are provided to the system processor 216 for processing. The receive channels 410-1 to 410-M of the transceiver 214 are coupled to the system processor 216, as shown in FIG. 5.

FIG. 5 illustrates an example scheme implemented by the radar system 102 for performing angular position estimation. In the depicted configuration, the system processor 216 implements the hardware-abstraction module 220 and the machine-learned module 222. The system processor 216 is connected to the receive channels 410-1 to 410-M. The system processor 216 can also communicate with the computer processor 202 (of FIG. 2). Although not shown, the hardware-abstraction module 220 and/or the machine-learned module 222 can be implemented by the computer processor 202.

In this example, the hardware-abstraction module 220 accepts the digital beat signals 428-1 to 428-M from the receive channels 410-1 to 410-M. The digital beat signals 428-1 to 428-M represent raw or unprocessed complex data. The hardware-abstraction module 220 performs one or more operations to generate complex range data 502-1 to 502-M based on digital beat signals 428-1 to 428-M. The hardware-abstraction module 220 transforms the complex data provided by the digital beat signals 428-1 to 428-M into a form that is expected by the machine-learned module 222. In some cases, the hardware-abstraction module 220 normalizes amplitudes associated with different transmit power levels or transforms the complex data into a frequency-domain representation.

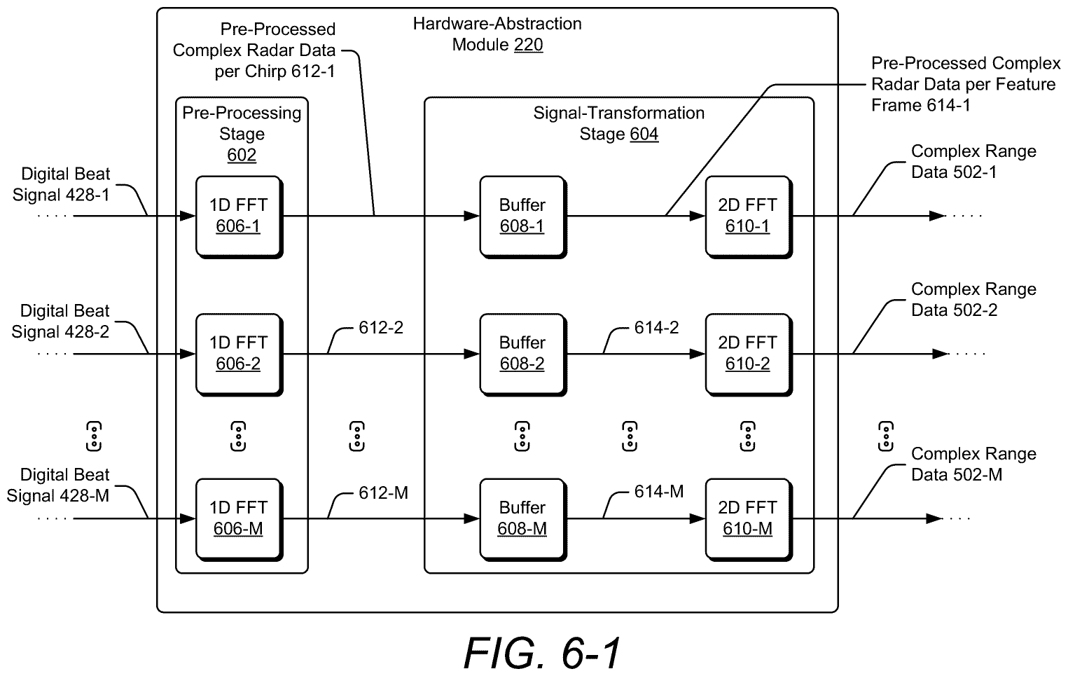

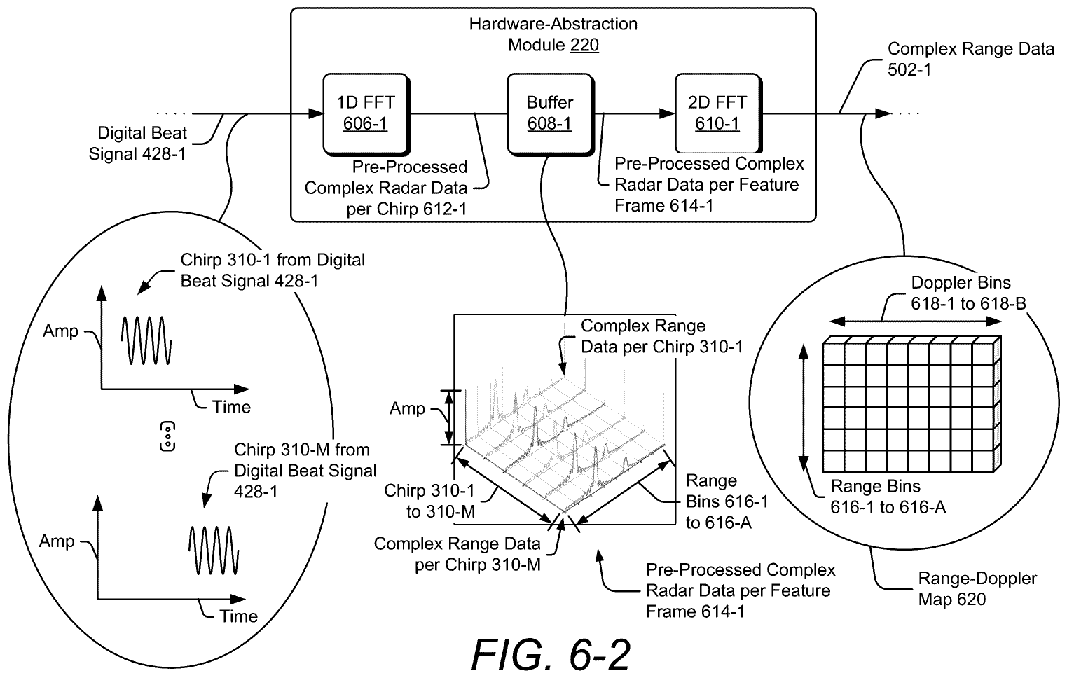

The complex range data 502-1 to 502-M includes both magnitude and phase information (e.g., in-phase and quadrature components). In some implementations, the complex range data 502-1 to 502-M includes range-Doppler maps for each receive channel 410-1 to 410-M and for a particular active feature frame 316, as further described with respect to FIG. 6-2. In other implementations, the complex range data 502-1 to 502-M includes complex interferometry data, which is an orthogonal representation of the range-Doppler maps. As another example, the complex range data 502-1 to 502-M includes frequency-domain representations of the digital beat signals 428-1 to 428-M for an active feature frame 316. Although not shown, other implementations of the radar system 102 can provide the digital beat signals 428-1 to 428-M directly to the machine-learned module 222.

In general, the complex range data 502-1 to 502-M has explicit range information for one or more objects within the external environment. The complex range data 502-1 to 502-M can be organized in terms of range. For example, each complex number within a range-Doppler map is associated with a particular range bin (e.g., a particular range interval), or each frequency within the frequency-domain representations of the digital beat signals 428-1 to 428-M represents a particular range.

It can be challenging to directly process the complex range data 502-1 to 502-M to extract angular information. This is because the complex range data 502-1 to 502-M is not ordered in terms of angular positions. Consequently, information elements within the complex range data 502-1 to 502-M can be associated with one or more angles, which can vary over time in terms of the quantity of associated angles and/or the particular angles themselves.

The machine-learned module 222 uses a trained regression model, a trained classification model, or some combination thereof to analyze the complex range data 502-1 to 502-M and generate angular position data 504. The machine-learned module 222 can provide the angular position data 504 to other modules executed by the system processor 216 or the computer processor 202. Example modules can include a tracking module, a clutter-map module, a gesture recognition module, a presence detection module, a collision-avoidance module, and/or a human vital-sign detection module.

In some implementations, the machine-learned module 222 relies on supervised learning and records measured (e.g., real) data for machine-learning training purposes. Training enables the machine-learned module 222 to learn a transformation or mapping function for generating the angular position data 504 based on the complex range data 502-1 to 502-M.

An example training procedure prompts a user 302 to stand at a particular angle or direction relative to an orientation of the smart device 104 (e.g., stand to the left or right of the smart device 104). While the user is at this position, the machine-learned module 222 records complex range data 502-1 to 502-M that is provided as input. The machine-learned module 222 adjusts machine-learning parameters (e.g., coefficients, weights, or biases) to recognize the angular position of the user 302 based on the recorded input data. The determined machine-learning parameters are stored by the system medium 218 or pre-programmed into the machine-learned module 222 to enable future angular positions of the user 302 to be estimated. In some cases, this process can be repeated multiple times to enable the machine-learned module 222 to estimate various angular positions of the user 302 and account for variances in how the user 302 positions themselves relative to the smart device 104.

An example offline training procedure uses a motion-capture system to generate truth data for training the machine-learned module 222. The motion-capture system can include multiple optical sensors, such as infrared-sensors or cameras to measure positions of multiple markers that are placed on different portions of a person's body, such as on an arm, a hand, a torso, or a head. While the person moves to different positions, the input data is recorded along with position data from the motion-capture system. The position data recorded from the motion-capture system is converted into position measurements with respect to the radar system 102 and represents truth data. The machine-learned module 222 analyzes the training data and the truth data together and adjusts machine-learning parameters to minimize errors. In some cases, the offline training procedure can provide a relatively noise-free environment and high-resolution truth data for training the machine-learned module 222.

Additionally or alternatively, a real-time training procedure can use available sensors within the smart device 104 to generate truth data for training the machine-learned module 222. In this case, a training procedure can be initiated by a user 302 of the smart device 104. While the user 302 moves around the smart device 104, data from optical sensors (e.g., a camera or an infra-red sensor) of the smart device 104 and the radar system 102 are collected and provided to the machine-learned module 222. The real-time training procedure enables the machine-learned module 222 to be tailored to the user 302, account for current environmental conditions, and account for a current position or orientation of the smart device 104.

The machine-learned module 222 includes at least one artificial neural networks (e.g., neural networks). A neural network includes a group of connected nodes (e.g., neurons or perceptrons), which are organized into one or more layers. As an example, the machine-learned module 222 includes a deep neural network, which includes an input layer, an output layer, and one or more hidden layers positioned between the input layer and the output layers. The nodes of the deep neural network can be partially-connected or fully connected between the layers.

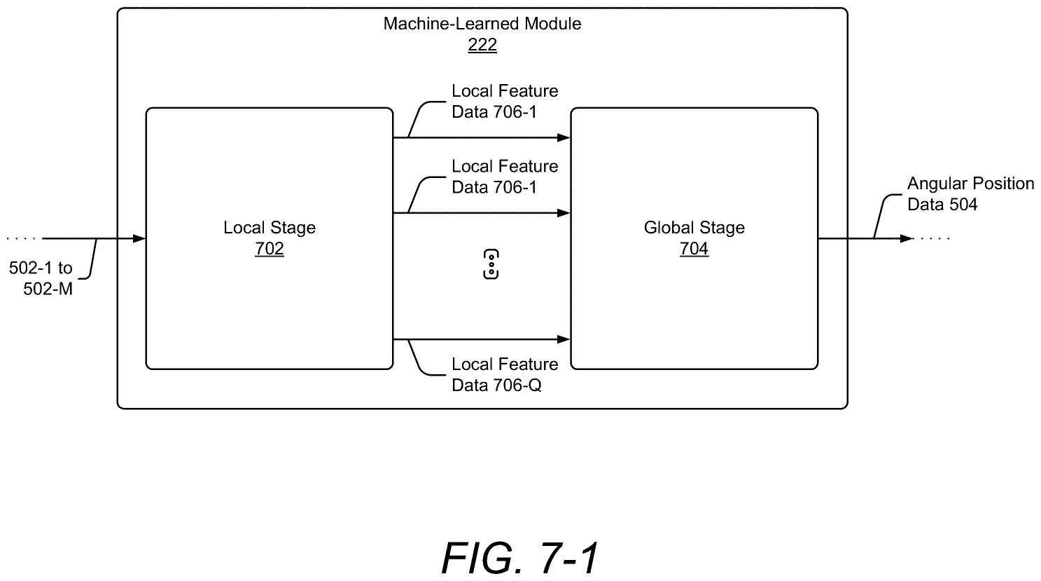

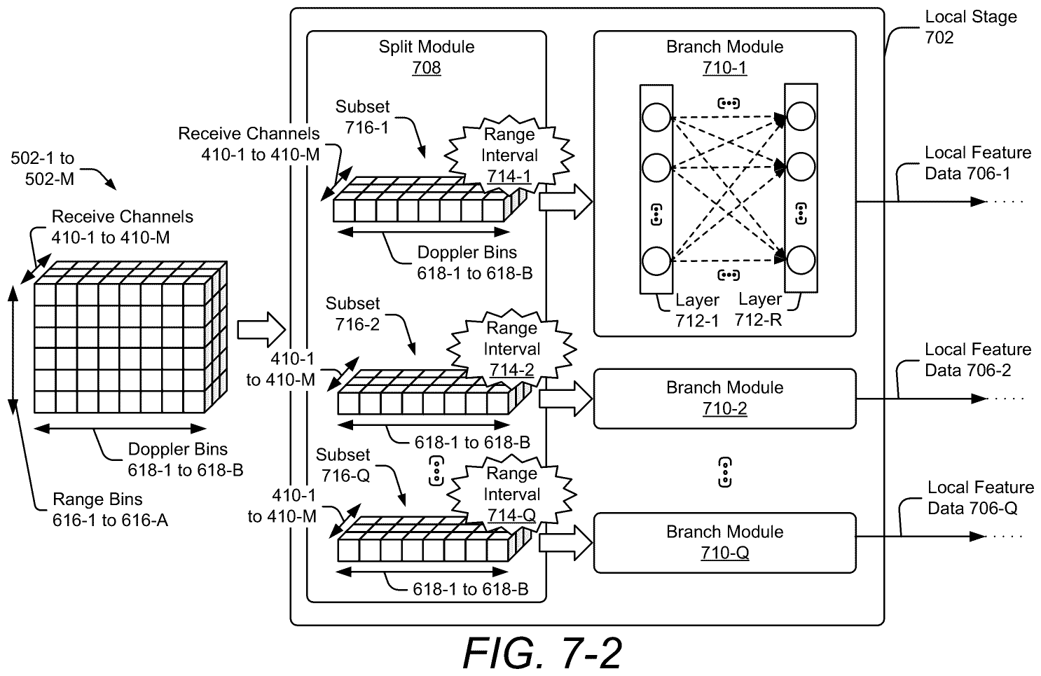

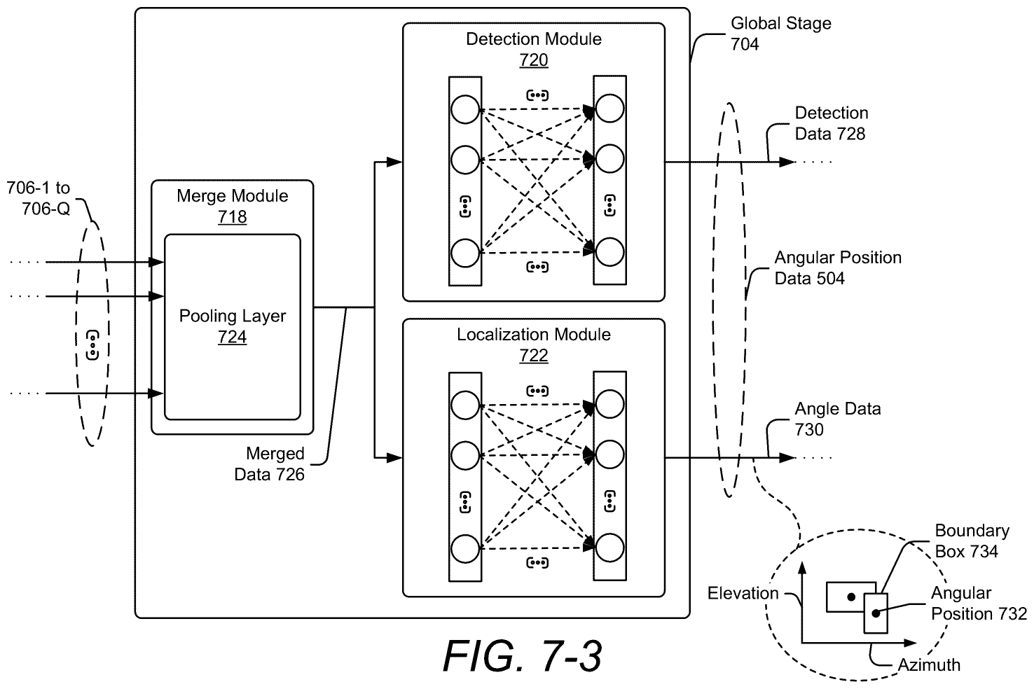

In some cases, the deep neural network is a recurrent deep neural network (e.g., along short-term memory (LSTM) recurrent deep neural network) with connections between nodes forming a cycle to retain information from a previous portion of an input data sequence for a subsequent portion of the input data sequence. In other cases, the deep neural network is a feed-forward deep neural network in which the connections between the nodes do not form a cycle. Additionally or alternatively, the machine-learned module 222 can include another type of neural network, such as a convolutional neural network. An example implementation of the machine-learned module 222 is further described with respect to FIG. 7-1.

FIG. 6-1 illustrates an example hardware-abstraction module 220 for angular position estimation. In the depicted configuration, the hardware-abstraction module 220 includes a pre-processing stage 602 and a signal-transformation stage 604. The pre-processing stage 602 operates on each chirp 310-1 to 310-N within the digital beat signals 428-1 to 428-M. In other words, the pre-processing stage 602 performs an operation for each active radar frame 322. In this example, the pre-processing stage 602 includes one-dimensional (1D) Fast-Fourier Transform (FFT) modules 606-1 to 606-M, which respectively process the digital beat signals 428-1 to 428-M. Other types of modules that perform similar operations are also possible, such as a Fourier Transform module.

The signal-transformation stage 604 operates on the sequence of chirps 310-1 to 310-M within each of the digital beat signals 428-1 to 428-M. In other words, the signal-transformation stage 604 performs an operation for each active feature frame 316. In this example, the signal-transformation stage 604 includes buffers 608-1 to 608-M and two-dimensional (2D) FFT modules 610-1 to 610-M.

During reception, the one-dimensional FFT modules 606-1 to 606-M perform individual FFT operations on the chirps 310-1 to 310-M within the digital beat signals 428-1 to 428-M. Assuming the radar receive signals 308-1 to 308-M include 16 chirps 310-1 to 310-N (e.g., N equals 16), each one-dimensional FFT module 606-1 to 606 M performs 16 FFT operations to generate pre-processed complex radar data per chirp 612-1 to 612-M. As the individual operations are performed, the buffers 608-1 to 608-M store the results. Once all of the chirps 310-1 to 310-M associated with an active feature frame 316 have been processed by the pre-processing stage 602, the information stored by the buffers 608-1 to 608-M represents pre-processed complex radar data per feature frame 614-1 to 614-M for the corresponding receive channels 410-1 to 410-M.

Two-dimensional FFT modules 610-1 to 610-M respectively process the pre-processed complex radar data per feature frame 614-1 to 614-M to generate the complex range data 502-1 to 502-M. In this case, the complex range data 502-1 to 502-M includes complex range-Doppler maps, as further described with respect to FIG. 6-2.

FIG. 6-2 illustrates example complex range data 502-1 generated by the hardware-abstraction module 220 for angular position estimation. The hardware-abstraction module 220 is shown to process a digital beat signal 428-1 associated with the receive channel 410-1. The digital beat signal 428-1 includes the chirps 310-1 to 310-M, which are time-domain signals. The chirps 310-1 to 310-M are passed to the one-dimensional FFT module 606-1 in an order in which they are received and processed by the transceiver 214.

As described above, the one-dimensional FFT module 606-1 performs an FFT operation on a first chirp 310-1 of the digital beat signal 428-1 at a first time. The buffer 608-1 stores a first portion of the pre-processed complex radar data 612-1, which is associated with the first chirp 310-1. The one-dimensional FFT module 606-1 continues to process subsequent chirps 310-2 to 310-N, and the buffer 608-1 continues to store the corresponding portions of the pre-processed complex radar data 612-1. This process continues until the buffer 608-1 stores a last portion of the pre-processed complex radar data 612-M, which is associated with the chirp 310-M.

At this point, the buffer 608-1 stores pre-processed complex radar data associated with a particular feature frame 614-1. The pre-processed complex radar data per feature frame 614-1 represents magnitude information (as shown) and phase information (not shown) across different chirps 310-1 to 310-N and across different range bins 616-1 to 616-A, where A represents a positive integer.

The two-dimensional FFT 610-1 accepts the pre-processed complex radar data per feature frame 614-1 and performs a two-dimensional FFT operation to form the complex range data 502-1, which represents a range-Doppler map 620. The range-Doppler map 620 includes complex data for the range bins 616-1 to 616-A and Doppler bins 618-1 to 618-B, where B represents a positive integer. In other words, each range bin 616-1 to 616-A and Doppler bin 618-1 to 618-B includes a complex number with real and imaginary parts that together represent magnitude and phase information. The quantity of range bins 616-1 to 616-A can be on the order of tens or hundreds, such as 32, 36, 64, or 128 (e.g., A equals 32, 36, 64, or 128). The quantity of Doppler bins can be on the order of tens or hundreds, such as 16, 32, 64, or 124 (e.g., B equals 16, 32, 64, or 124). The complex range data 502-1, along with the complex range data 502-2 to 502-M (of FIG. 6-1), are provided to the machine-learned module 222, as shown in FIG. 7-1.

FIG. 7-1 illustrates an example machine-learned module 222 for performing angular position estimation. In the depicted configuration, the machine-learned module 222 includes two stages: a local stage 702 and a global stage 704. The local stage 702 accepts the complex range data 502-1 to 502-M, which are respectively associated with the receive channels 410-1 to 410-M of FIG. 5. In different implementations, the complex range data 502-1 to 502-M can include multiple range-Doppler maps 620 (of FIG. 6-2), pre-processed complex radar data (e.g., pre-processed complex radar data per chirp 612-1 to 612-M or pre-processed complex radar data per feature frame 614-1 to 614-M of FIG. 6-1), time-domain or frequency-domain representations of the multiple digital beat signals 428-1 to 428-M, or complex interferometry data (e.g., orthogonal representations of the range-Doppler maps 620).

In general, the complex range data 502-1 to 502-M includes complex numbers, which have explicit range information and implicit angle information (e.g., implicit azimuth information and/or elevation information). Examples of the explicit range information within the complex range data 502-1 to 502-M can include the range bins 616-1 to 616-A of the range-Doppler maps 620, the range bins 616-1 to 616-A of the pre-processed complex radar data per chirp 612-1 to 612-M, the range bins 616-1 to 616-A of the pre-processed complex radar data per feature frame 614-1 to 614-M, or the frequencies of the digital beat signals 428-1 to 428-M.

The local stage 702 separately analyzes different range intervals of the complex range data 502-1 to 502-M and generates local feature data 706-1 to 706-Q, where Q represents a positive integer associated with the quantity of range intervals analyzed. The global stage 704 merges the local feature data 706-1 to 706-Q using a symmetric function and generates the angular position data 504. The angular position data 504 can include information about whether or not an object is present and angular information about a present object. The angular position data 504 can be represented using spherical coordinates (e.g., azimuth and/or elevation) or cartesian coordinates (e.g., X, Y, and/or Z).

In some implementations, the local stage 702 and the global stage 704 can be implemented using a PointNet class of machine-learning architectures. Some PointNet modules are trained to process spatially arranged input data (e.g., input data comprising a three-dimensional point cloud with explicit angular information). In contrast, the machine-learned module 222 is trained to process complex range data 502-1 to 502-M, which has implicit angular information. As such, the machine-learned module 222 can operate independent of an order in which the complex range data 502-1 to 502-M is arranged and provided to the local stage 702. In other words, the machine-learned module 222 is insensitive to an arrangement of the complex range data 502-1 to 502-M if this arrangement is static (e.g., does not vary over time). Example implementations of the local stage 702 and the global stage 704 are further described with respect to FIGS. 7-2 and 7-3, respectively.

FIG. 7-2 illustrates an example local stage 702 of the machine-learned module 222. In the depicted configuration, the local stage 702 includes a split module 708 and multiple branch modules 710-1 to 710-Q. Each branch module 710-1 to 710-Q includes a neural network with one or more layers 712-1 to 712-R, where R is a positive integer. The value of R can vary depending on the implementation. As an example, R can equal 2, 4, or 10. The layers 712-1 to 712-R can be fully-connected or partially-connected. Nodes within the layers 712-1 to 712-R can execute an activation function, for instance. The branch modules 710-1 to 710-Q can also perform additions and/or multiplications.

The branch modules 710-1 to 710-Q have similar architectures and utilize the same machine-learning parameters (e.g., coefficients and weights). In some implementations, the branch modules 710-1 to 710-Q can include a shared layer, which can calculate a global feature across the branch modules 710-1 to 710-Q. As an example, the shared layer can include a pooling layer, such as a max pooling layer or an average pooling layer.

During operation, the complex range data 502-1 to 502-M is provided to the split module 708. In this example, the complex range data 502-1 to 502-M includes multiple range-Doppler maps 620, which are respectively associated with the receive channels 410-1 to 410-M.

The split module 708 provides different subsets of the complex range data 502-1 to 502-M to the branch modules 710-1 to 710-Q. In particular, the split module 708 splits the complex range data 502-1 to 502-M into different range intervals 714-1 to 714-Q to generate different subsets 716-1 to 716-Q of the complex range data 502-1 to 502-M. In this example, each range interval 714-1 to 714-Q includes a particular range bin 616-1 to 616-A such that there is a 1:1 mapping between the range bins 616-1 to 616-A and the range intervals 714-1 to 714-Q (e.g., Q is equal to A). For example, the range interval 714-1 can include the range bin 616-1. This results in the first subset 716-1 including the complex numbers associated with the range bin 616-1, the Doppler bins 618-1 to 618-B, and the receive channels 410-1 to 410-M. Likewise, the range interval 714-2 can include the range bin 616-2. This results in the second subset 716-2 including the complex numbers associated with the range bin 616-2, the Doppler bins 618-1 to 618-B, and the receive channels 410-1 to 410-M.

In other examples, each range interval 714-1 to 714-Q can include more than one range bin 616-1 to 616-A (e.g., a set of range bins 616-1 to 616-A). In other words, there can be a 2:1, 3:1, or 5:1 mapping between the range bins 616-1 to 616-A and the range intervals 714-1 to 714-Q. In some cases, the set of range bins 616-1 to 616-A associated with each range interval 714-1 to 714-Q includes neighboring range bins. For example, the range interval 714-1 can include a first set of three neighboring range bins 616 (e.g., range bins 616-1 to 616-3) and the range interval 714-2 can include a second set of three neighboring range bins 616 (e.g., range bins 616-4 to 616-6). In general, the size of the range intervals 714-1 to 714-Q can be tailored based on an estimated size of the object and/or a range resolution of the radar system 102.

Although not explicitly shown, some implementations of the split module 708 can further split or separate the complex range data 502-1 to 502-M across other dimensions, such as across different Doppler intervals or across different sets of receive channels. In this case, the input provided to each branch module 710-1 to 710-Q can be associated with a particular range interval 714, a particular Doppler interval, and/or a particular set of receive channels 410. In an example implementation, the subsets 716-1 to 716-Q are each associated with a particular range bin 616-1 to 616-A and a particular Doppler bin 618-1 to 618-B. For example, the subset 716-1 includes the complex numbers associated the range bin 616-1, the Doppler bin 618-1, and the receive channels 410-1 to 410-M. Likewise, the subset 716-2 includes the complex numbers associated with the range bin 616-1, the Doppler bin 618-2, and the receive channels 410-1 to 410-M.

The split module 708 provides these different subsets 716-1 to 716-Q of the complex range data 502-1 to 502-M as input data to the respective branch modules 710-1 to 710-Q. In particular, each complex number within a subset 716-1 to 716-Q is provided as an input to one of the nodes within the layer 712-1. In some implementations, the split module 708 also provides information identifying the range bins 616-1 to 616-A, the Doppler bins 618-1 to 618-B, and/or the receive channels 410-1 to 410-M associated with the subsets 716-1 to 716-Q. Although this can increase complexity of the machine-learned module 222, this additional information can help improve the accuracy of the machine-learned module 222 for generating the angular position data 504.

Using the layers 712-1 to 712-R, the branch module 710-1 analyzes the first subset 716-1 of the complex range data 502-1 to 502-M and generates local feature data 706-1. Similar operations are also performed by the branch modules 710-2 to 718-Q. Each local feature data 706-1 to 706-Q represents a vector, which can have a particular length (e.g., 32, 100, or 1000). The local feature data 706-1 to 706-Q represents a projection of its corresponding subset 716-1 to 716-Q of the complex range data 502-1 to 502-M in at least an angular space. As an example, each local feature data 706-1 to 706-Q can include information that identifies which azimuth and/or elevation bins are active (e.g., which angular bins are likely to include one or more objects).

For smart devices 104 with less computational capability, the split module 708 can be designed to separate the complex range data 502-1 to 502-M into fewer subsets 716-1 to 716-Q. This enables the machine-learned module 222 to be implemented with fewer branch modules 710-1 to 710-Q within the local stage 702 and operate on a smaller amount of local feature data 706-1 to 706-Q within the global stage 704. In this way, the machine-learned module 222 can utilize less computational resources and memory. However, this can increase the complexity associated with training the machine-learned module 222 to recognize the angular information within the complex range data 502-1 to 502-M. In general, an architecture of the machine-learned module 222 can be tailored to satisfy a variety of different computational or memory resource constraints. The local feature data 706-1 to 706-Q is provided to the global stage 704, as further described with respect to FIG. 7-3.

FIG. 7-3 illustrates an example global stage 704 of the machine-learned module 222. In the depicted configuration, the global stage 704 includes a merge module 718, a detection module 720, and a localization module 722. The merge module 718 executes a symmetric function to combine the local feature data 706-1 to 706-Q. Because the merge module 718 uses a symmetric function, the local feature data 706-1 to 706-Q can be unordered or contain different information. For example, the local feature data 706-1 can include information about a first angular position while the local feature data 706-2 can include information a second angular position, which may or may not be correspond to the first angular position.

The detection module 720 and the localization module 722 further transform the data to generate the angular position data 504. The detection module 720 and the localization module 722 can be implemented using other neural networks with fully-connected or partially-connected layers. In some implementations, the detection module 720 is implemented as a classification model and the localization module 722 is implemented as a regression model. Other implementations are also possible. Although both the detection module 720 and the localization module 722 are shown in FIG. 7-3, the global stage 704 can generally include the detection module 720, the localization module 722, both the detection module 720 and the localization module 722 (as shown), or a single module that represents a combination of the detection module 720 and the localization module 722.

During operation, the merge module 718 merges (e.g., combines) the local feature data 706-1 to 706-Q using a symmetric function. For example, the merge module 718 can include a pooling layer 724, which down samples the local feature data 706-1 to 706-Q. The pooling layer 724 can be implemented as a max pooling layer, which calculates a maximum value for portions of the local feature data 706-1 to 706-Q, or an average pooling layer, which calculates an average value for portions of the local feature data 706-1 to 706-Q. The merge module 718 provides merged data 726 to the detection module 720 and the localization module 722.

The detection module 720 analyzes the merged data 726 and generates detection data 728. The detection data 728 identifies whether or not an object is present within a particular angular region (e.g., angular space or angular interval). As an example, the detection data 728 includes a vector which each element representing a particular azimuth and/or elevation region. The detection module 720 sets a value of an element within this vector equal to one to represent relatively high confidence of an object being present within the angular region represented by the element. Alternatively, the detection module 720 sets a value of an element equal to zero to represent relatively low confidence of an object being present within the angular region represented by the element. Instead, if the detection module 720 is implemented as a regression model, the values of the elements can represent the amount of confidence associated with each angular position, which can have values between 0% to 100%. The detection data 728 is considered part of the angular position data 504.

In some implementations, the detection module 720 can be further expanded to classify the type of object detected. For example, the detection module 720 can indicate whether the object is likely an inanimate object, a person (e.g., the user 302), an animal, a vehicle, and so forth.

The localization module 722 analyzes the merged data 726 and generates angle data 730. The angle data 730 identifies angular positions of the objects that are detected by the detection module 720. For example, the angle data 730 can include an angular position 732 for each object in terms of azimuth and/or elevation. The angle data 730 can also include a boundary box 734 for each object. The boundary box 734 indicates a size of the object across the azimuth and/or elevation dimensions. The angle data 730 is considered part of the angular position data 504.

Although not shown, the angle data 730 can be expanded to also include range data. In this case, the output of the localization module 722 can include a three-dimensional position in spherical or cartesian coordinates for each object identified by the detection module 720. The boundary box 734 can further indicate a size of the object across the range dimension.

### Example Method

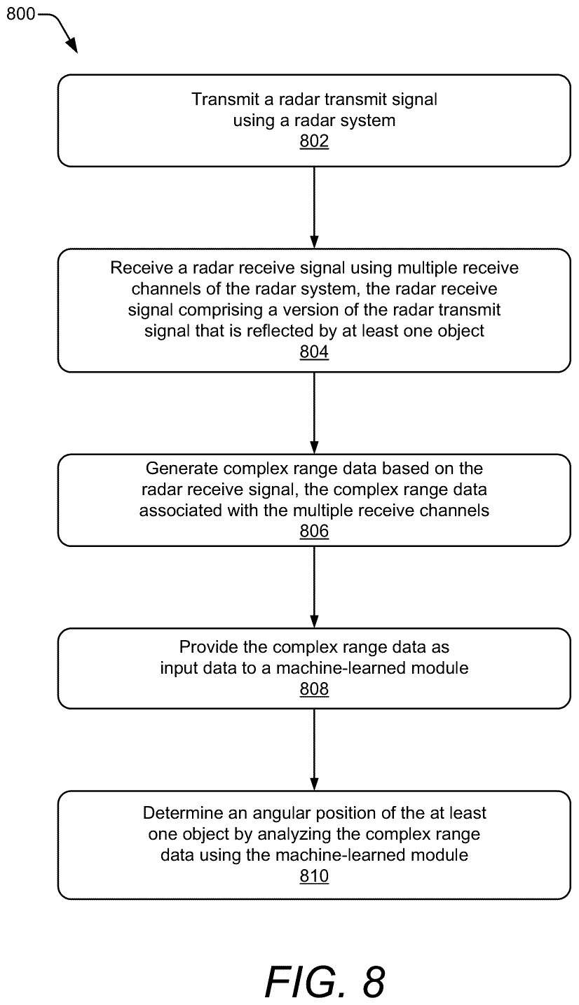

FIG. 8 depicts an example method 800 for performing operations of a smart-device-based radar system. Method 900 is shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100-1 to 100-6 of FIG. 1, and entities detailed in FIG. 2 or 5, reference to which is made for example only. The techniques are not limited to performance by one entity or multiple entities operating on one device.

At 802, a radar transmit signal is transmitted using a radar system. For example, the radar system 102 transmits the radar transmit signal 306, as shown in FIG. 3-1. The radar transmit signal 306 can include multiple chirps 310-1 to 310-N, whose timing can be determined based on the radar framing structure 312 of FIG. 3-2.

At 804, a radar receive signal is received using multiple receive channels of the radar system. The radar receive signal comprises a version of the radar transmit signal that is reflected by at least one object. For example, the radar system 102 receives the radar receive signal 308 using multiple receive channels 410-1 to 410-M, as shown in FIG. 4. The radar receive signal 308 represents a version of the radar transmit signal 306 that is reflected by at least one object (e.g., an inanimate object, the user 302, or an animal), as shown in FIG. 3-1.

At 806, complex range data is generated based on the radar receive signal. The complex range data is associated with the multiple receive channels. For example, the radar system 102 generates the complex range data 502-1 to 502-M based on the radar receive signal 308 (e.g., based on the digital beat signals 428-1 to 428-M derived from the radar receive signal 308), as shown in FIG. 5. The complex range data 502-1 to 502-M is associated with the multiple receive channels 410-1 to 410-M. In various implementations, the complex range data 502-1 to 502-M can include multiple range-Doppler maps 620 (of FIG. 6-2), pre-processed complex radar data (e.g., pre-processed complex radar data per chirp 612-1 to 612-M or pre-processed complex radar data per feature frame 614-1 to 614-M of FIG. 6-1), time-domain or frequency-domain representations of the multiple digital beat signals 428-1 to 428-M, or complex interferometry data (e.g., orthogonal representations of the range-Doppler maps 620). In general, the complex range data 502-1 to 502-M includes explicit range information and implicit angular (e.g., azimuth and/or elevation) information.

At 808, the complex range data is provided as input data to a machine-learned module. For example, the system processor 216 of the radar system 102 provides the complex range data 502-1 to 502-M to the machine-learned module 222, as shown in FIG. 5. In various implementations, the machine-learned module 222 can be integrated within the radar system 102 (e.g., stored within the system medium 218 and executed by the system processor 216) or implemented separate from the radar system 102 (e.g., stored within the computer-readable medium 204 and executed by the computer processor 202). If the machine-learned module 222 is separate from the radar system 102, the radar system 102 can use the communication interface 210 to pass the complex range data 502-1 to 502-M to the machine-learned module 222.

At 810, an angular position of the at least one object is determined by analyzing the complex range data using the machine-learned module. For example, the machine-learned module 222 determines the angular position 732 of the at least one object by analyzing the complex range data 502-1 to 502-M. In some implementations, the machine-learned module 222 can also determine the range of the at least one object and/or a size of the object across one or more dimensions.

### Example Computing System

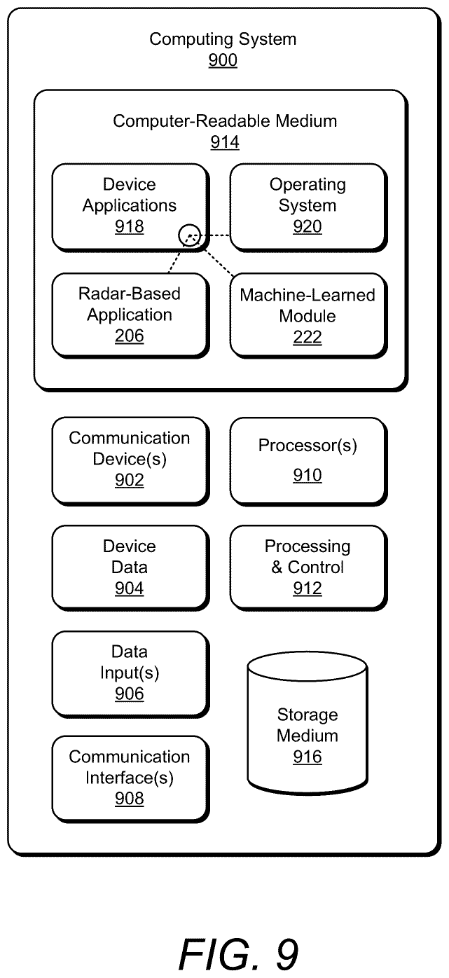

FIG. 9 illustrates various components of an example computing system 900 that can be implemented as any type of client, server, and/or computing device as described with reference to the previous FIG. 2 to implement angular position estimation.

The computing system 900 includes communication devices 902 that enable wired and/or wireless communication of device data 904 (e.g., received data, data that is being received, data scheduled for broadcast, or data packets of the data). Although not shown, the communication devices 902 or the computing system 900 can include one or more radar systems 102. The device data 904 or other device content can include configuration settings of the device, media content stored on the device, and/or information associated with a user 302 of the device. Media content stored on the computing system 900 can include any type of audio, video, and/or image data. The computing system 900 includes one or more data inputs 906 via which any type of data, media content, and/or inputs can be received, such as human utterances, the radar-based application 206, user-selectable inputs (explicit or implicit), messages, music, television media content, recorded video content, and any other type of audio, video, and/or image data received from any content and/or data source.

The computing system 900 also includes communication interfaces 908, which can be implemented as any one or more of a serial and/or parallel interface, a wireless interface, any type of network interface, a modem, and as any other type of communication interface. The communication interfaces 908 provide a connection and/or communication links between the computing system 900 and a communication network by which other electronic, computing, and communication devices communicate data with the computing system 900.

The computing system 900 includes one or more processors 910 (e.g., any of microprocessors, controllers, and the like), which process various computer-executable instructions to control the operation of the computing system 900 and to enable techniques for, or in which can be embodied, angular position estimation. Alternatively or in addition, the computing system 900 can be implemented with any one or combination of hardware, firmware, or fixed logic circuitry that is implemented in connection with processing and control circuits which are generally identified at 912. Although not shown, the computing system 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 900 also includes a computer-readable medium 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 900 can also include a mass storage medium device (storage medium) 916.

The computer-readable medium 914 provides data storage mechanisms to store the device data 904, as well as various device applications 918 and any other types of information and/or data related to operational aspects of the computing system 900. For example, an operating system 920 can be maintained as a computer application with the computer-readable medium 914 and executed on the processors 910. The device applications 918 may include a device manager, such as any form of a control application, software application, signal-processing and control module, code that is native to a particular device, a hardware abstraction layer for a particular device, and so on.

The device applications 918 also include any system components, engines, or managers to implement angular. In this example, the device applications 918 includes the radar-based application 206 and the machine-learned module 222 of FIG. 2.

### CONCLUSION

Although techniques using, and apparatuses including, a smart-device-based radar system capable of performing angular position estimation have been described in language specific to features and/or methods, it is to be understood that the subject of the appended claims is not necessarily limited to the specific features or methods described. Rather, the specific features and methods are disclosed as example implementations of a smart-device-based radar system performing angular position estimation.

Some examples are described below:

Example 1: A method comprising:
transmitting a radar transmit signal using a radar system;
receiving a radar receive signal using multiple receive channels of the radar system, the radar receive signal comprising a version of the radar transmit signal that is reflected by at least one object;
generating complex range data based on the radar receive signal, the complex range data associated with the multiple receive channels;
providing the complex range data as input data to a machine-learned module; and
determining an angular position of the at least one object by analyzing the complex range data using the machine-learned module.

Example 2: The method of example 1, wherein the angular position comprises at least one of the following:
an azimuth angle of the at least one object; or
an elevation angle of the at least one object.

Example 3: The method of example 1 or 2, wherein the determining of the angular position of the at least one object further comprises at least one of the following:
determining a size of the at least one object across an azimuth dimension; or
determining a size of the at least one object across an elevation dimension.

Example 4: The method of any preceding example, wherein the complex range data comprises:
explicit range information; and
implicit angular information; in particular expressed as complex numbers.

Example 5: The method of example 4, wherein the complex range data comprises:
multiple range-Doppler maps respectively associated with the multiple receive channels; complex interferometry data associated with each of the multiple receive channels; pre-processed complex radar data associated with each of the multiple receive channels; and/or
multiple digital beat signals respectively associated with the multiple receive channels, the multiple digital beat signals derived from the radar receive signal.

Example 6: The method of any preceding example, wherein the determining of the angular position comprises:
separately processing, by a local stage of the machine-learned module, different range intervals of the complex range data to generate local feature data for each of the different range intervals; and
merging, by a global stage of the machine-learned module, the local feature data using a symmetric function to generate angular position data, the angular position data including the angular position of the at least one object.

Example 7: The method of example 6, wherein the separate processing of the different range intervals comprises:
splitting the complex range data into a first subset of the complex range data based on a first range interval;
splitting the complex range data into a second subset of the complex range data based on a second range interval;
passing the first subset of the complex range data to a first branch module within the local stage, the first branch module comprising a first neural network;
generating, by the first branch module, first local feature data of the local feature data;
passing the second subset of the complex range data to a second branch module within the local stage, the second branch module comprising a second neural network; and
generating, by the second branch module, second local feature data of the local feature data.

Example 8: The method of example 7, wherein the first neural network and the second neural network have a same network architecture and utilize same machine-learning parameters.

Example 9: The method of example 7, wherein:
the complex range data comprises multiple range-Doppler maps respectively associated with the multiple receive channels;
the splitting of the complex range data into the first subset further comprises splitting the complex range data into the first subset of the complex range data based on the first range interval and a first Doppler interval; and
the splitting of the complex range data into the second subset further comprises splitting the complex range data into the second subset of the complex range data based on the second range interval and a second Doppler interval.

Example 10: The method of example 9, wherein:
the multiple range-Doppler maps each include complex numbers respectively associated with multiple range bins and multiple Doppler bins;
the first subset of the complex range data includes a complex number associated with a first range bin of the multiple range bins and a first Doppler bin of the multiple Doppler bins; and
the second subset of the complex range data includes another complex number associated with a second range bin of the multiple range bins and a second Doppler bin of the multiple Doppler bins.

Example 11: The method of example 10, wherein:
the passing of the first subset of the complex range data to the first branch module further comprises passing information that identifies the first range bin and the first Doppler bin to the first branch module; and
the passing of the second subset of the complex range data to the second branch module further comprises passing other information that identifies the second range bin and the second Doppler bin to the second branch module.

Example 12: The method of example 6, wherein:
the complex range data comprises multiple range bins, each range bin including a complex number; and
the different range intervals each include:
   one range bin of the multiple range bins; or
   a set of range bins of the multiple range bins, the set of range bins comprising neighboring range bins.

Example 13: The method of example 6, wherein the global stage includes a pooling layer.

Example 14: The method of any preceding example, further comprising:
determining a slant range of the at least one object by analyzing the complex range data using the machine-learned module.

Example 15: The method of example 14, wherein the determining of the slant range of the at least one object further comprises determining a size of the at least one object across a range dimension.

Example 16: An apparatus comprising:
a radar system comprising:
   an antenna array; and
   a transceiver comprising at least two receive channels respectively coupled to antenna elements of the antenna array;
a processor; and
a computer-readable storage medium comprising computer-executable instructions that, responsive to execution by the processor, implement a machine-learned module,
the radar system, the processor, and the computer-readable storage medium jointly configured to perform any of the methods of examples 1 to 15.

Example 17: The apparatus of example 16, wherein the apparatus comprises a smart device, the smart device comprising one of the following:
a smartphone;
a smart watch;
a smart speaker;
a smart thermostat;
a security camera;
a vehicle; or
a household appliance.

Example 18: The apparatus of example 16 or 17, wherein the processor and the computer-readable storage medium are integrated within the radar system.

Example 19: The apparatus according to any of examples 16 to 18, wherein the antenna array comprises two, three, or four antenna elements.

Example 20: A computer-readable storage medium comprising computer-executable instructions that, responsive to execution by a processor, implement a machine-learned module configured to:
accept complex range data associated with a radar receive signal that is reflected by at least one object, the complex range data associated with multiple receive channels of a radar system;
separately process different range intervals of the complex range data to generate local feature data for each of the different range intervals;
merge the local feature data using a symmetric function to generate angular position data, the angular position data including an angular position of the at least one object; and
determine the angular position of the at least one object based on the angular position data.

Example 21: The computer-readable storage medium of example 20, wherein the complex range data comprises:
multiple range-Doppler maps respectively associated with the multiple receive channels;
complex interferometry data associated with each of the multiple receive channels;
pre-processed complex radar data associated with each of the multiple receive channels; and/or
multiple digital beat signals respectively associated with the multiple receive channels, the multiple digital beat signals derived from the radar receive signal.

1. A method comprising:
transmitting a radar transmit signal using a radar system;
receiving a radar receive signal using multiple receive channels of the radar system, the radar receive signal comprising a version of the radar transmit signal that is reflected by at least one object;
generating complex range data based on the radar receive signal, the complex range data associated with the multiple receive channels;
providing the complex range data as input data to a machine-learned module; and
determining an angular position of the at least one object by analyzing the complex range data using the machine-learned module.

2. The method of claim 1, wherein the angular position comprises at least one of the following:
an azimuth angle; or
an elevation angle.

3. The method of claim 1, wherein the determining of the angular position of the at least one object further comprises at least one of the following:
determining a size of the at least one object across an azimuth dimension; or
determining a size of the at least one object across an elevation dimension.

4. The method of claim 1, wherein the complex range data comprises:
explicit range information; and
implicit angular information; in particular expressed as complex numbers.

5. The method of claim 4, wherein the complex range data comprises:
multiple range-Doppler maps respectively associated with the multiple receive channels;
complex interferometry data associated with each of the multiple receive channels;
pre-processed complex radar data associated with each of the multiple receive channels; or
multiple digital beat signals respectively associated with the multiple receive channels, the multiple digital beat signals derived from the radar receive signal.

6. The method of claim 1, wherein the determining the angular position comprises:
separately processing, by a local stage of the machine-learned module, different range intervals of the complex range data to generate local feature data for each of the different range intervals; and
merging, by a global stage of the machine-learned module, the local feature data using a symmetric function to generate angular position data, the angular position data including the angular position of the at least one object.

7. The method of claim 6, wherein the separate processing of the different range intervals comprises:
splitting the complex range data into a first subset of the complex range data based on a first range interval;
splitting the complex range data into a second subset of the complex range data based on a second range interval;
passing the first subset of the complex range data to a first branch module within the local stage, the first branch module comprising a first neural network;
generating, by the first branch module, first local feature data of the local feature data;
passing the second subset of the complex range data to a second branch module within the local stage, the second branch module comprising a second neural network; and
generating, by the second branch module, second local feature data of the local feature data.

8. The method of claim 7, wherein the first neural network and the second neural network have a same architecture and utilize same machine-learning parameters.

9. The method of claim 7, wherein:
the complex range data comprises multiple range-Doppler maps respectively associated with the multiple receive channels;
the splitting of the complex range data into the first subset further comprises splitting the complex range data into the first subset of the complex range data based on the first range interval and a first Doppler interval; and
the splitting of the complex range data into the second subset further comprises splitting the complex range data into the second subset of the complex range data based on the second range interval and a second Doppler interval.

10. The method of claim 9, wherein:
the multiple range-Doppler maps each include complex numbers respectively associated with multiple range bins and multiple Doppler bins;
the first subset of the complex range data includes a complex number associated with a first range bin of the multiple range bins and a first Doppler bin of the multiple Doppler bins; and
the second subset of the complex range data includes another complex number associated with a second range bin of the multiple range bins and a second Doppler bin of the multiple Doppler bins.

11. The method of claim 10, wherein:
the passing of the first subset of the complex range data to the first branch module further comprises passing information that identifies the first range bin and the first Doppler bin to the first branch module; and
the passing of the second subset of the complex range data to the second branch module further comprises passing other information that identifies the second range bin and the second Doppler bin to the second branch module.

12. The method of claim 6, wherein:
the complex range data comprises multiple range bins, each range bin including a complex number; and
the different range intervals each include:
one range bin of the multiple range bins; or
a set of range bins of the multiple range bins, the set of range bins comprising neighboring range bins.

13. The method of claim 6, wherein the global stage includes a pooling layer.

14. The method of claim 1, further comprising:
determining a slant range of the at least one object by analyzing the complex range data using the machine-learned module.

15. The method of claim 14, wherein the determining of the slant range of the at least one object further comprises determining a size of the at least one object across a range dimension.

16. An apparatus comprising:
a radar system comprising:
a transceiver configured to:
transmit a radar transmit signal;
receive a radar receive signal using at least two receive channels, the radar receive signal comprising a version of the radar transmit signal that is reflected by at least one object; and
generate complex range data based on the radar receive signal, the complex range data associated with the at least two receive channels;
a processor; and
a computer-readable storage medium comprising computer-executable instructions that, responsive to execution by the processor, implement a machine-learned module configured to:
generate local feature data for different range intervals by separately processing the different range intervals of the complex range data;
generate angular position data by merging the local feature data using a symmetric function, the angular position data including an angular position of the at least one object; and
determine the angular position of the at least one object based on the angular position data.

17. The apparatus of claim 16, wherein the apparatus comprises a smart device, the smart device comprising one of the following:
a smartphone;
a smart watch;
a smart speaker;
a smart thermostat;
a security camera;
a vehicle; or
a household appliance.

18. The apparatus of claim 16, wherein the processor and the computer-readable storage medium are integrated within the radar system.

19. (canceled)

20. A computer-readable storage medium comprising computer-executable instructions that, responsive to execution by a processor, implement a machine-learned module configured to:
accept complex range data associated with a radar receive signal that is reflected by at least one object, the complex range data associated with multiple receive channels of a radar system;
separately process different range intervals of the complex range data to generate local feature data for each of the different range intervals;
merge the local feature data using a symmetric function to generate angular position data, the angular position data including an angular position of the at least one object; and
determine the angular position of the at least one object based on the angular position data.

21. The computer-readable storage medium of claim 20, wherein the complex range data comprises:
multiple range-Doppler maps respectively associated with the multiple receive channels;
complex interferometry data associated with each of the multiple receive channels;
pre-processed complex radar data associated with each of the multiple receive channels; or
multiple digital beat signals respectively associated with the multiple receive channels, the multiple digital beat signals derived from the radar receive signal.
